(19) United States
(12) Patent Application Publication
(10) Pub. No.: US 2025/0056207 A1
(43) Pub. Date: Feb. 13, 2025

(54) HANDLING OF GROUPS OF USER EQUIPMENT IN A CORE NETWORK

(71) Applicant: Telefonaktiebolaget LM Ericsson (publ), Stockholm (SE)

(72) Inventors: Juan Manuel Fernandez Galmes, Madrid (ES); Emiliano Merino Vazquez, Madrid (ES); Jose Miguel Dopico Sanjuan, Madrid (ES); Jesus Angel de Gregorio Rodriguez, Madrid (ES)

(21) Appl. No.: 18/851,318

(22) PCT Filed: Nov. 24, 2022
(86) PCT No.: PCT/EP2022/083149

§ 371 Date: Sep. 26, 2024

(30) Foreign Application Priority Data
Mar. 29, 2022 (EP) 22382297.4

(51) Int. Cl. H04W 8/18

(52) U.S. Cl. CPC H04W 8/186

(57) ABSTRACT

There is provided techniques for handling groups of UEs in a core network. A method is performed by an NEF node in the core network. An indication that a group of UEs is formed is obtained. The group of UEs is associated with a single virtual External Group Identifier. It is identified to which UDM group each of the UEs belongs. Each UDM group comprise at least one UDM node. The method comprises sending a request to each identified UDM group for the UEs to be added to the group of UEs, and for each identified UDM group to, for the group of UEs, allocate a respective External Group Identifier which will serve the group of UEs. A respective External Group Identifier for the group of UEs is received from each identified UDM group. All the received External Group Identifiers are identified with the single virtual External Group Identifier.

### TECHNICAL FIELD

Embodiments presented herein relate to methods, a Network Exposure Function node, a Unified Data Management node, computer programs, and a computer program product for handling groups of User Equipment in a core network.

### BACKGROUND

In general terms, a fifth-generation (5G) system (5GS) is a telecommunication system using the 5G New Radio (NR) air interface, or the Evolved Universal Terrestrial Radio Access (E-UTRA) air interface connected to a 5G core network (5GC). The 5GC comprises functional entities called Network Functions (NFs). System functionality is achieved by a set of NFs providing services to other authorized NFs to access their services. Each NF offers different functionalities and thereby provides different services.

FIG. 1 is a schematic diagram illustrating a communication network 10. The communication network 10 might be regarded as a public land mobile network (PLMN) and represents a reference architecture of a 5GS and comprises the following entities: an Authentication Server Function (AUSF) node 45, an Access and Mobility Management Function (AMF) node 50, a Data Network (DN) 80, e.g. operator services, Internet access or third party services, a Network Exposure Function (NEF) node 100, a Network Repository Function (NRF) node 20, a Network Slice Selection Function (NSSF) node 15, a Policy Control Function (PCF) node 25, a Session Management Function (SMF) node 55, a Unified Data Manager (UDM) node 200, a Unified Data Repository (UDR) node 40, a User Plane Function (UPF) node 75, an Application Function (AF) node 30, a User Equipment (UE) 85, a (Radio) Access Network ((R)AN) 70, a Network Data Analytics Function (NWDAF) node 60, a Binding Support Function (BSF) node 35, and a Charging Function (CHF) node 65. Service based interfaces are represented by the format Nxyz (e.g., Nnssf, Nnef, etc.) and point to point interfaces are represented by the format Nx (e.g. N1, N2, etc.).

In general terms, the 5G System supports management of 5G Virtual Network (VN) Group identification and membership (i.e., definition of 5G VN group identifiers and membership) and 5G VN Group data (i.e., definition of 5G VN group data). The 5G VN Group management can be configured by a network administrator or can be managed dynamically by AF. A 5G VN group is characterized by 5G VN group identities, 5G VN group membership, and 5G VN group data. With respect to 5G VN group identities, an External Group ID and an Internal Group ID are used to identify each 5G VN group. The 5G VN group members are uniquely identified by their Generic Public Subscription Identifier (GPSI). The 5G VN group data may include the following parameters: Protocol Data Unit (PDU) session type, Data Network Name (DNN), Single Network Slice Selection Assistance Information (S-NSSAI) and Application descriptor, Information related with secondary authentication/authorization (e.g., to enable IP address assignment by the Data Network Authentication Authorization and Accounting (DN-AAA) server).

A 5G VN group is identified by the AF using the External Group ID. The NEF provides the External Group ID to the UDM. The UDM maps the External Group ID to the Internal Group ID. For a newly created 5G VN group, an Internal Group ID is allocated by the UDM. The NEF can retrieve the Internal Group ID from the UDM via Nudm_SDM_Get service operation (External Group ID, Group Identifier translation). In this respect, in the technical specification 3GPP TS 23.501 entitled “System architecture for the 5G System (5GS)” version 17.3.0 is included the following note in Section 5.29.2:

NOTE 1: It is assumed that all members of a 5G VN group belong to the same UDM Group Identifier. The NEF can select a UDM instance supporting the UDM Group Identifier of any of the member GPSIs of the 5G VN group.

Here, a UDM Group ID refers to one or more UDM instances managing a specific set of SUPIs. A UDM Group consists of one or multiple UDM sets. This implies that all UE group members must be associated with the same UDM Group Identifier. In other words, the existing 3GPP standards do not allow to have different UE group members belonging to different UDM Group Identifiers.

### SUMMARY

An object of embodiments herein is to address the above issues.

According to a first aspect there is presented a method for handling groups of UEs in a core network. The method is performed by an NEF node in the core network. The method comprises obtaining an indication that a group of UEs is formed. The group of UEs is associated with a single virtual External Group Identifier. The method comprises identifying to which UDM group each of the UEs belongs. Each UDM group comprise at least one UDM node. The method comprises sending a request to each identified UDM group for the UEs to be added to the group of UEs, and for each identified UDM group to, for the group of UEs, allocate a respective External Group Identifier which will serve the group of UEs. The method comprises receiving, from each identified UDM group, a respective External Group Identifier for the group of UEs. The method comprises associating all the received External Group Identifiers with the single virtual External Group Identifier.

According to a second aspect there is presented a NEF node for handling groups of UEs in a core network. The NEF node comprises processing circuitry. The processing circuitry is configured to cause the NEF node to obtain an indication that a group of UEs is formed. The group of UEs is associated with a single virtual External Group Identifier. The processing circuitry is configured to cause the NEF node to identify to which UDM group each of the UEs belongs. Each UDM group comprise at least one UDM node. The processing circuitry is configured to cause the NEF node to send a request to each identified UDM group for the UEs to be added to the group of UEs, and for each identified UDM group to, for the group of UEs, allocate a respective External Group Identifier which will serve the group of UEs. The processing circuitry is configured to cause the NEF node to receive, from each identified UDM group, a respective External Group Identifier for the group of UEs. The processing circuitry is configured to cause the NEF node to associate all the received External Group Identifiers with the single virtual External Group Identifier.

According to a third aspect there is presented a NEF node for handling groups of UEs in a core network. The NEF node comprises an obtain module configured to obtain an indication that a group of UEs is formed. The group of UEs is associated with a single virtual External Group Identifier. The NEF node comprises an identify module configured to identify to which UDM group each of the UEs belongs. Each UDM group comprise at least one UDM node. The NEF node comprises a send module configured to send a request to each identified UDM group for the UEs to be added to the group of UEs, and for each identified UDM group to, for the group of UEs, allocate a respective External Group Identifier which will serve the group of UEs. The NEF node comprises a receive module configured to receive, from each identified UDM group, a respective External Group Identifier for the group of UEs. The NEF node comprises an associate module configured to associate all the received External Group Identifiers with the single virtual External Group Identifier.

According to a fourth aspect there is presented a computer program for handling groups of UEs in a core network, the computer program comprising computer program code which, when run on processing circuitry of an NEF node, causes the NEF node to perform a method according to the first aspect.

According to a fifth aspect there is presented a method for handling groups of UEs in a core network. The method is performed by a UDM node in the core network. The method comprises obtaining a request from a NEF node, for at least one UE to be added to a group of UEs and to, for the group of UEs, allocate an External Group Identifier which will serve the group of UEs. The method comprises allocating the External Group Identifier to the group of UEs. The method comprises sending the External Group Identifier for the group of UEs to the NEF node.

According to a sixth aspect there is presented a UDM node for handling groups of UEs in a core network. The UDM node comprises processing circuitry. The processing circuitry is configured to cause the UDM node to obtain a request from a NEF node, for at least one UE to be added to a group of UEs and to, for the group of UEs, allocate an External Group Identifier which will serve the group of UEs. The processing circuitry is configured to cause the UDM node to allocate the External Group Identifier to the group of UEs. The processing circuitry is configured to cause the UDM node to send the External Group Identifier for the group of UEs to the NEF node.

According to a seventh aspect there is presented a UDM node for handling groups of UEs in a core network. The UDM node comprises an obtain module configured to obtain a request from a NEF node, for at least one UE to be added to a group of UEs and to, for the group of UEs, allocate an External Group Identifier which will serve the group of UEs. The UDM node comprises an allocate module configured to allocate the External Group Identifier to the group of UEs. The UDM node comprises a send module configured to send the External Group Identifier for the group of UEs to the NEF node.

According to an eighth aspect there is presented a computer program for handling groups of UEs in a core network, the computer program comprising computer program code which, when run on processing circuitry of a UDM node, causes the UDM node to perform a method according to the fifth aspect.

According to a ninth aspect there is presented a computer program product comprising a computer program according to at least one of the fourth aspect and the eighth aspect and a computer readable storage medium on which the computer program is stored. The computer readable storage medium could be a non-transitory computer readable storage medium.

Advantageously, these aspects enable a third-party application (as represented by the AF) to manage a group of UEs with one single/unique External Group Identifier, no matter the set of UEs in the group and how the network is partitioned. This is achieved in an automated manner, without requiring any manual intervention by the MNO.

Other objectives, features and advantages of the enclosed embodiments will be apparent from the following detailed disclosure, from the attached dependent claims as well as from the drawings.

Generally, all terms used in the claims are to be interpreted according to their ordinary meaning in the technical field, unless explicitly defined otherwise herein. All references to “a/an/the element, apparatus, component, means, module, step, etc.” are to be interpreted openly as referring to at least one instance of the element, apparatus, component, means, module, step, etc., unless explicitly stated otherwise. The steps of any method disclosed herein do not have to be performed in the exact order disclosed, unless explicitly stated.

### BRIEF DESCRIPTION OF THE DRAWINGS

The inventive concept is now described, by way of example, with reference to the accompanying drawings, in which:

FIG. 1 is a schematic diagram illustrating a communication network according to embodiments;

FIGS. 2 and 3 are flowcharts of methods according to embodiments;

FIGS. 4 and 5 are signalling diagrams according to embodiments;

FIG. 6 is a schematic diagram showing functional units of an NEF node according to an embodiment;

FIG. 7 is a schematic diagram showing functional modules of an NEF node according to an embodiment;

FIG. 8 is a schematic diagram showing functional units of a UDM node according to an embodiment;

FIG. 9 is a schematic diagram showing functional modules of a UDM node according to an embodiment; and

FIG. 10 shows one example of a computer program product comprising computer readable means according to an embodiment.

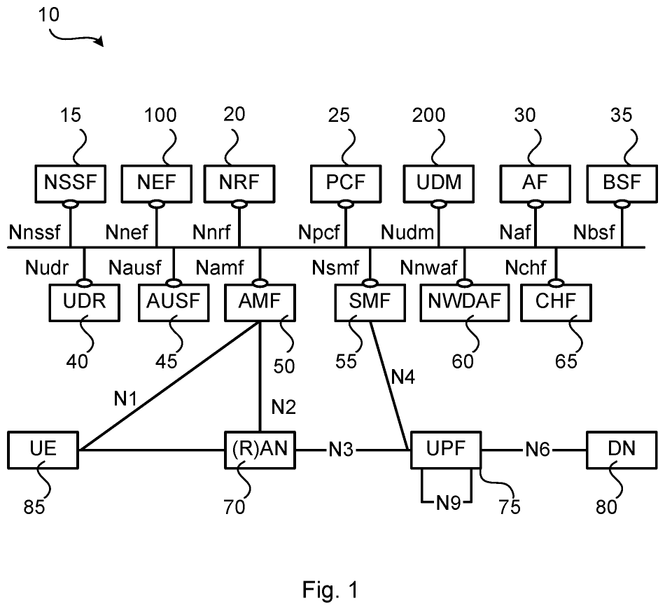

### DETAILED DESCRIPTION

The inventive concept will now be described more fully hereinafter with reference to the accompanying drawings, in which certain embodiments of the inventive concept are shown. This inventive concept may, however, be embodied in many different forms and should not be construed as limited to the embodiments set forth herein; rather, these embodiments are provided by way of example so that this disclosure will be thorough and complete, and will fully convey the scope of the inventive concept to those skilled in the art. Like numbers refer to like elements throughout the description. Any step or feature illustrated by dashed lines should be regarded as optional.

As noted above, existing 3GPP standards do not allow to have different UE group members belonging to different UDM Group Identifiers. Issues with this as discovered by the inventors of the present disclosure will be further illustrated below.

As an illustrative non-limiting example, assume that there are three groups of UDMs, each having its own group identifier (UDM group ID=1, UDM group ID=2, and UDM group ID=3) and where each such group of UDMs comprises at least one UDM. Assume further that:
UDM group ID=1 serves SUPIs 1-99,
UDM group ID=2 serves SUPIs 100-199, and
UDM group ID=3 serves SUPIs 200-299.

If the MNO and/or AF require(s) that UEs with SUPIs 50-51, SUPIs 150-151 and SUPIs 250-251 are to be group members of the same External Group Identifier, before adding these UEs to the group of UEs, the MNO needs to perform a re-allocation of the UEs (by means of the SUPIs) to be served as follows, where the UDM group with UDM group ID=1 is serving the External Group Identifier identifying the group of UEs:
UDM group ID=1 serves SUPIs 1-99, SUPIs 150-151, SUPIs 250-251,
UDM group ID=2 serves SUPIs 100-149, SUPIs 152-199, and
UDM group ID=3 serves SUPIs 200-249, SUPIs 252-299.

This procedure works well if the UEs (or at least the SUPIs) are not previously split in different UDM groups. However, if the UEs (or at least the SUPIs) are already split into different UDM groups, it could be complicated and tedious for the MNO to reallocate the SUPIs so that the group of UEs is solely managed by a single UDM group. Typically, the MNO will allocate the SUPIs as convenient as possible (e.g., according to SUPI ranges, MNO requirements, other network information, etc.) for the UDM grouping so, if a group of UEs is created a later stage, some technique is required in order to make the groups of UEs usable.

One technique is to split the group of UEs into several groups of UEs, where each group of UEs is managed by a respective UDM group. Continuing the above illustrative example this yields:
UDM group ID=1 serves External Group group1@domain.com. The external group contains SUPIs 50-51,
UDM group ID=2 serves External Group group2@domain.com. The external group contains SUPIs 150-151, and
UDM group ID=3 serves External Group group3@domain.com. The external group contains SUPIs 250-251.

It is here noted that the remaining SUPIs not associated with any External Group Identifiers are served by the UDM groups as initially disclosed (e.g., UDM group ID=1 also serves SUPIs 1-49).

In terms of Network Exposure, it is advantageous for the MNO to offer, display, or provide, a single group of UEs to external AFs. This is since the AFs should not, or at least need not to, be aware of the internal data model, or grouping of UEs or SUPIs, in the 5GC network. In the present illustrative example, it might therefore not be reasonable to require the AF to manage three groups of UEs as if they were a single group, since this would involve the AF to submit three requests (one for each group of UEs) for each procedure initiated by the AF. In the worst case, the MNO would be requiring the AFs to send as many requests as there are UDM Group Identifiers in the network if there are UE group members belonging to all UDM groups.

The embodiments disclosed herein therefore relate to techniques for handling groups of UEs 85 in a core network. In order to obtain such techniques there is provided an NEF node 100, a method performed by the NEF node 100, a computer program product comprising code, for example in the form of a computer program, that when run on processing circuitry of the NEF node 100, causes the NEF node 100 to perform the method. In order to obtain such techniques there is further provided a UDM node 200, a method performed by the UDM node 200, and a computer program product comprising code, for example in the form of a computer program, that when run on processing circuitry of the UDM node 200, causes the UDM node 200 to perform the method.

Upon instruction by the NEF node 100, the UDM node 200 for each different UDM group generates an External Group Identifier. Each External Group Identifier will be managed by means of a UDM group identifier, so that, internally in the 5GC network, all UEs 85 in a group are managed by means of the same External Group Identifier.

All generated External Group Identifiers will be associated by the NEF node 100 and the UDM node 200 to a single virtual External Group Identifier as managed by the AF node 30. The association between the External Group Identifier and the single virtual External Group Identifier is stored in the UDR node 40 for persistency so that the MNO is aware that each group of UEs 85 is related to an AF-managed group (as identified by the virtual External Group Identifier), but does not contain all UE members, but only the UE members served by the UDM group. UDM instances subscribe to changes in other UDM NF profiles of the group and utilize a notification filtering criterion so that only when there is a new External Group Identifier being served by the UDM group, the rest of UDM instances within the group store such a new (generated by the UDM node) External Group Identifier as part of their NF profiles.

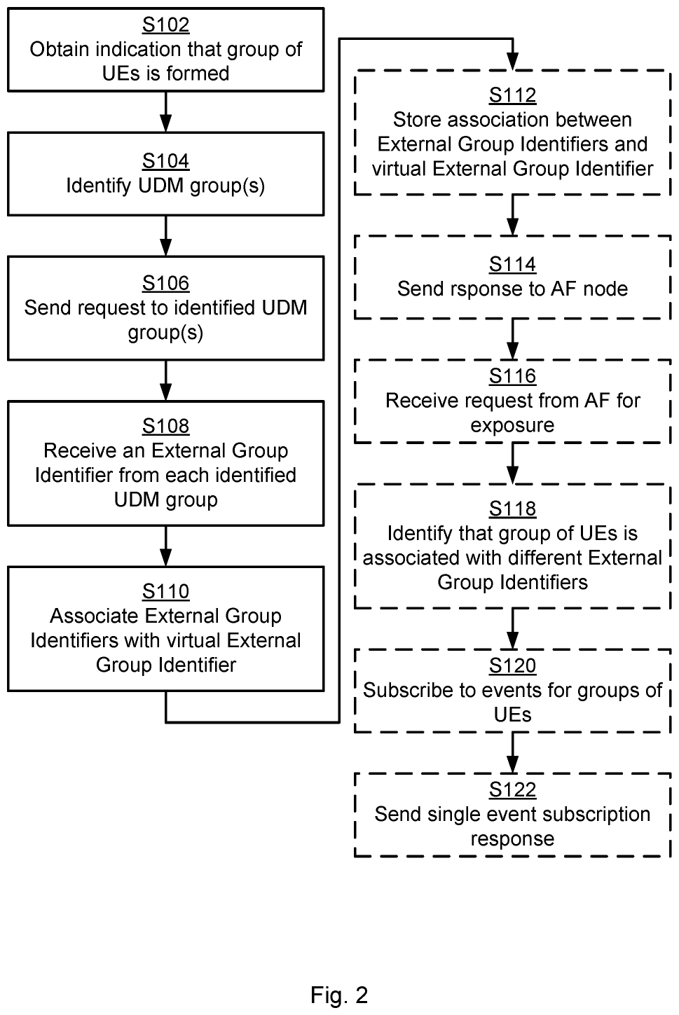

Reference is now made to FIG. 2 illustrating a method for handling groups of UEs 85 in a core network as performed by the NEF node 100 according to an embodiment. In some embodiments, the core network is a 5G core network.
S102: The NEF node 100 obtains an indication that a group of UEs 85 is formed. The group of UEs 85 is associated with a single virtual External Group Identifier.
S104: The NEF node 100 identifies to which UDM group each of the UEs 85 belongs. Each UDM group comprise at least one UDM node 200.
S106: The NEF node 100 sends a request to each identified UDM group for the UEs 85 to be added to the group of UEs 85, and for each identified UDM group to, for the group of UEs 85, allocate a respective External Group Identifier which will serve the group of UEs 85.
S108: The NEF node 100 receives, from each identified UDM group, a respective External Group Identifier for the group of UEs 85.
S110: The NEF node 100 associates all the received External Group Identifiers with the single virtual External Group Identifier.

Embodiments relating to further details of handling groups of UEs 85 in a core network as performed by the NEF node 100 will now be disclosed.

In some aspects, the group of UEs 85 is formed either by the AF node 30 as a new 5G virtual network group, or by an MNO. Hence, in some embodiments, the indication that the group of UEs 85 is formed is obtained either from an AF node 30 or from an MNO node.

In some aspects, for each UE 85, the NEF 100 performs a discovery via the NRF 20 to locate its UDM group. In particular, in some embodiments, identifying to which UDM group each of the UEs 85 belongs involves the NEF node 100 to perform a discovery procedure with an NRF node 20.

In some aspects, the NEF node 100 stores the single virtual External group Identifier and the association to the UDM group which includes the generated External Group Identifier. Hence, in some embodiments, the NEF node 100 is configured to perform (optional) step S112.
S112: The NEF node 100 stores an association between the received External Group Identifiers and the single virtual External Group Identifier.

In some aspects, once all the UDM groups have responded, each including its External Group Identifier, the NEF 100 returns a response to the AF node 30. Hence, in some embodiments, the NEF node 100 is configured to perform (optional) step S114.
S114: The NEF node 100 sends a response to an AF node 30 upon having received the External Group Identifiers from the identified UDM groups.

In some aspects, when the NEF node 100 receives from the AF node 30 a request for event exposure related to a group of UEs 85, the NEF node 100 identifies the received AF-managed External Group Identifier as a “virtual” group comprised of different External Group Identifiers, each one corresponding to a different UDM group. The NEF node 100 then subscribes to events for each group of UEs 85 sending a request to a UDM instance of each UDM group. The NEF 100 might then aggregate the information of the responses from each UDM group into a single event subscription response that is sent to the AF node 30. Hence, in some embodiments, the NEF node 100 is configured to perform (optional) steps S116-S122.
S116: The NEF node 100 receives, from an AF node 30, a request for exposure related to the group of UEs 85 as identified by the single virtual External Group Identifier;
S118: The NEF node 100 identifies, based on the single virtual External Group Identifier, that the group of UEs 85 is associated with different External Group Identifiers.
S120: The NEF node 100 subscribes to events for the group of UEs 85 by sending a request to each UDM group associated with the External Group Identifiers.
S122: The NEF node 100 sends a single event subscription response to the AF node 30 as an aggregate of information of responses received from said each UDM group.

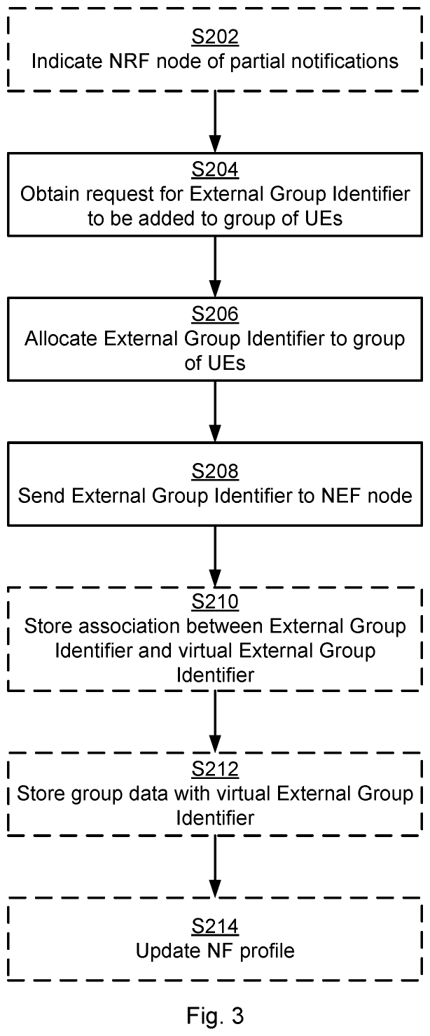

Reference is now made to FIG. 3 illustrating a method for handling groups of UEs 85 in a core network as performed by the UDM node 200 according to an embodiment. In some embodiments, the core network is a 5G core network.

As disclosed above, the NEF node 100 in step S106 sends a request to each identified UDM group for the UEs 85 to be added to the group of UEs 85. It is here assumed that this request is received by the UDM node 200.
S204: The UDM node 200 obtains a request from an NEF node 100, for at least one UE 85 to be added to a group of UEs 85 and to, for the group of UEs 85, allocate an External Group Identifier which will serve the group of UEs 85.
S206: The UDM node 200 allocates the External Group Identifier to the group of UEs 85.
S208: The UDM node 200 sends the External Group Identifier for the group of UEs 85 to the NEF node 100.

Embodiments relating to further details of handling groups of UEs 85 in a core network as performed by the UDM node 200 will now be disclosed.

In some aspects, the request comprises the above-mentioned single virtual External Group Identifier. That is, in some embodiments, the request comprises a single virtual External Group Identifier for the group of UEs 85, and the single virtual External Group Identifier is common for all groups of UDMs serving the group of UEs 85.

In some aspects, the single virtual External Group Identifier is permanently stored in the UDR node 40. In particular, in some embodiments, the UDM node 200 is configured to perform (optional) step S210.
S210: The UDM node 200 stores an association between the External Group Identifier and the single virtual External Group Identifier.

In some aspects, the UDM node 200 also stores the single virtual External Group Identifier as part of group data. In particular, in some embodiments, the UDM node 200 is configured to perform (optional) step S212.
S212: The UDM node 200 stores group data of the group of UEs 85. The single virtual External Group Identifier is stored as part of the group data.

In some aspects, the UDM node 200 updates its NF profile, ‘UDM info’, to indicate that two new External Group Identifiers (i.e., the External Group Identifier and the single virtual External Group Identifier) are managed/served. Hence, in some embodiments, the UDM node 200 has an NF profile, and the UDM node 200 is configured to perform (optional) step S214.
S214: The UDM node 200 updates the NF profile to indicate that UEs 85 of the External Group Identifier and the single virtual External Group Identifier are served by the UDM node 200.

In some aspects, the UDM node 200 included a parameter to indicate to the NRF node 20 that partial notifications should be sent only when there is a change in External Group Identifiers support/management. In particular, in some embodiments, the UDM node 200 is part of a UDM group and the UDM node 200 is configured to perform (optional) step S202.
S202: The UDM node 200 indicates to an NRF node 20 that partial notifications of NF profiles for the UDM group are to be sent to the UDM node 200 only when there is a change in External Group Identifiers support in the UDM group.

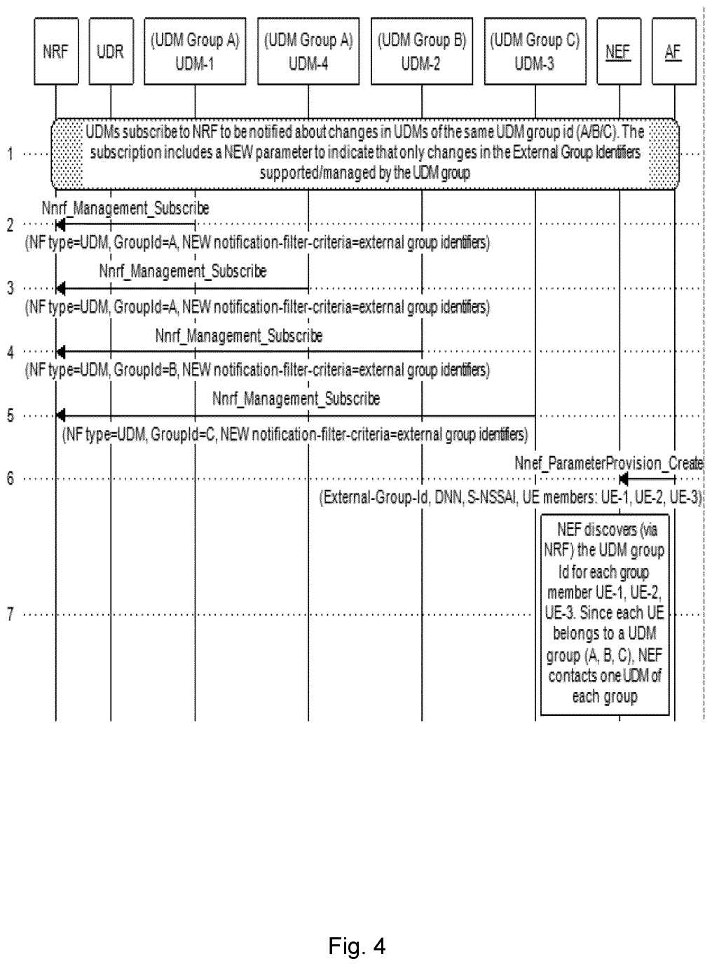

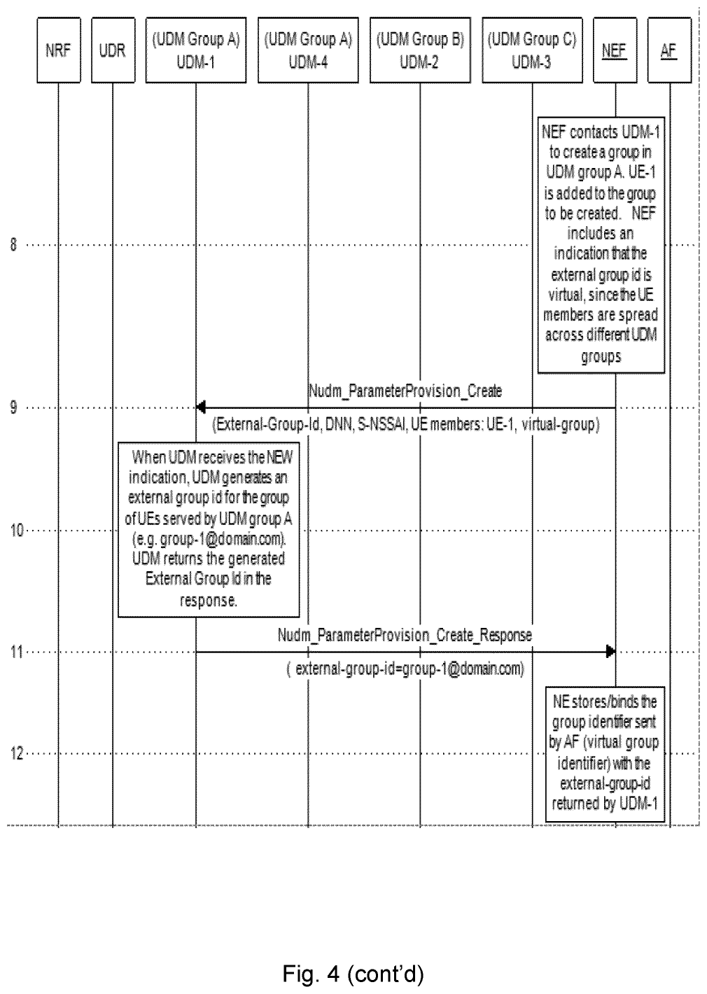

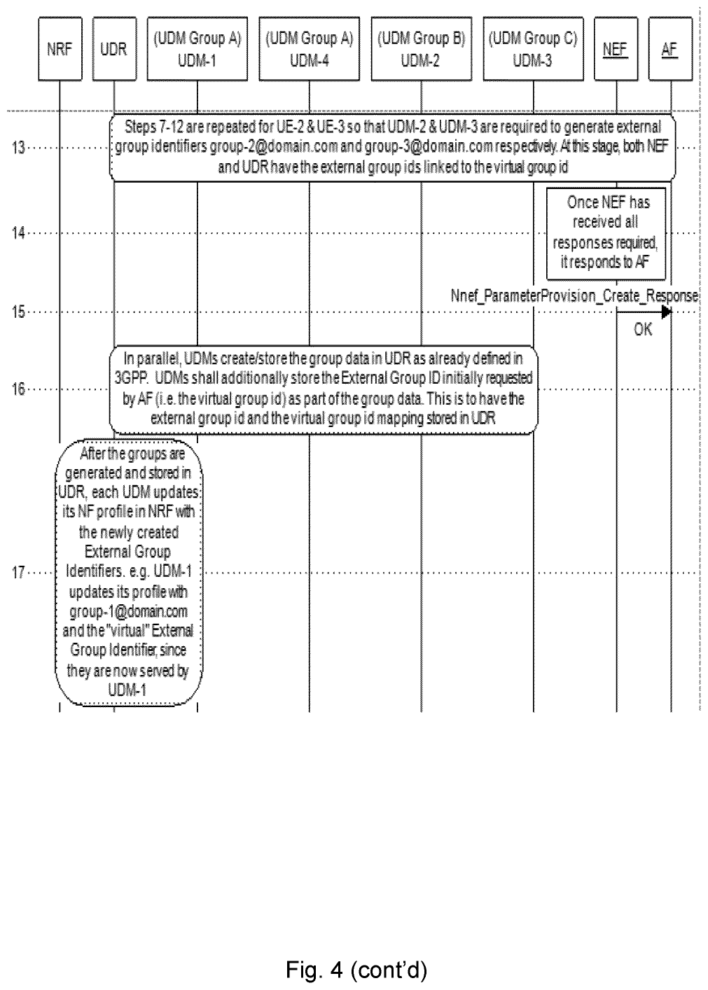

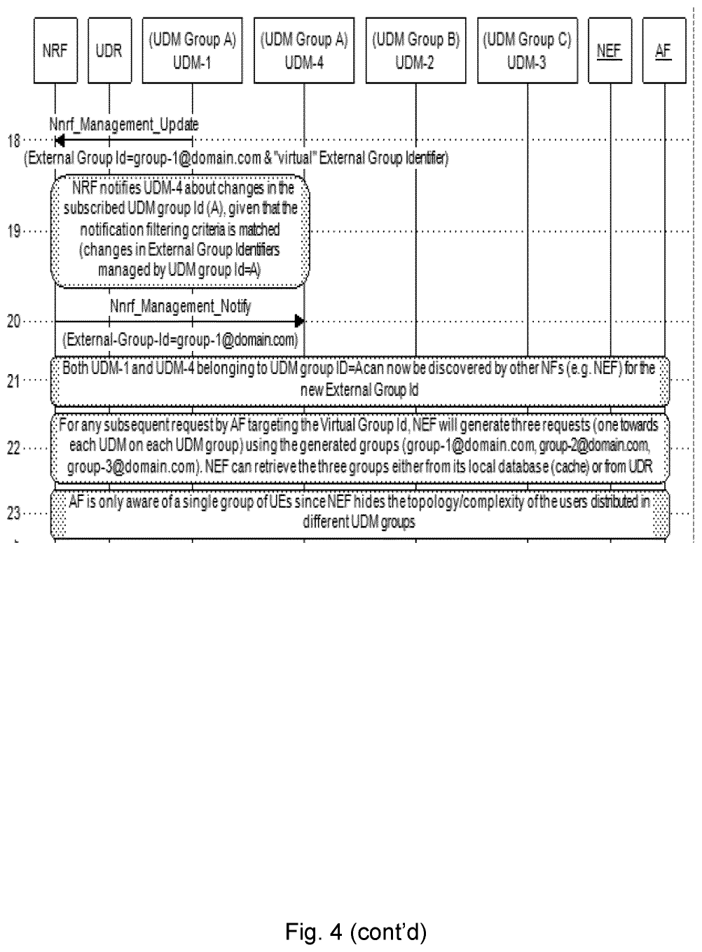

A first particular embodiment for handling groups of UEs 85 in a core network based on at least some of the above disclosed embodiments will now be disclosed in detail with reference to the signalling diagram of FIG. 4. This embodiment represents a scenario where groups of UEs are created by an AF as a 5G virtual network (VN) group.
S301-S305: UDMs subscribe to changes in UDM NF profiles (UDM info) associated to their own UDM Group Identifier. Since each UDM is only interested in NF profile changes for external group identifiers being managed by its UDM group, UDMs include a parameter to indicate that partial notifications should be sent only when there is a change in External Group Identifiers support/management. This parameter intends to avoid NRF notifying UDMs for all other changes since such other changes do not need to be synchronized across UDMs of the same UDM group.
S306: AF creates a new 5G VN group and includes three UE members at the time of creation.
S307: NEF inspects the request and the UE members to be added to the group. For each UE member, NEF performs a discovery via NRF to locate the UDM group.
S308-S309: For each UDM group identified, NEF sends the request including the External Group Identifier included by AF. Additionally, NEF also includes an indication to request UDM to allocate an External Group Identifier which will serve the associated UE (e.g., UE-1 for UDM group A). This indication informs UDMs about the External Group Identifier being “virtual” since the UE members are spread across different UDM groups, and hence the need for UDM to allocate an External Group Identifier to contain UEs being served by its UDM group.
S310-S311: UDM responds. UDM returns the generated External Group Identifier in the response towards NEF.
S312: NEF stores the single virtual External Group Identifier and the association to UDM group A which includes the generated External Group Identifier.
S313-S315: Once all the UDM groups (i.e., one UDM within each UDM group) have responded, each including its External Group Id, NEF returns the response to AF. At this moment, NEF has stored each External Group Identifier returned by UDM groups A, B and C and the association to the “virtual” group indicated by the AF.
S316: Each UDM stores 5G VN group data in UDR. Additionally, UDMs also store the single virtual External Group Identifier as part of the group data, so that the association between the External Group Identifier (generated previously) and the single virtual External Group Identifier is also permanently stored in UDR (e.g., in case NEF retrieves such information).
S317-S318: Since UDM-1 is serving now its External Group Identifier and the single virtual External Group Identifier (corresponding to the Group Identifier initially sent by the AF), UDM-1 updates its NF profile (UDM info) to indicate that two new External Group Identifiers are managed/served (i.e., managed by the UDM group A).
S319-S320: NRF notifies all UDMs within the UDM group (e.g., UDM-4) since they subscribed to changes in NF profiles of UDM group A and the notification filtering criteria is met (that is, changes in External Group Identifiers occurred).
S321-S323: AF only manages one single group of UEs, since NEF hides the complexity of the 5GC network and partitioning of UEs.

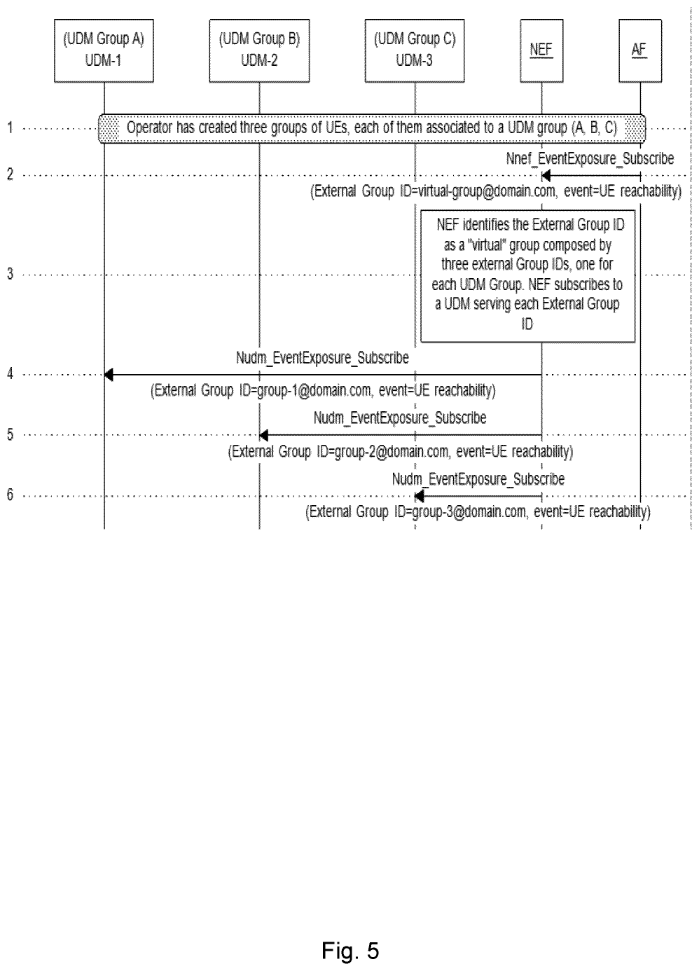

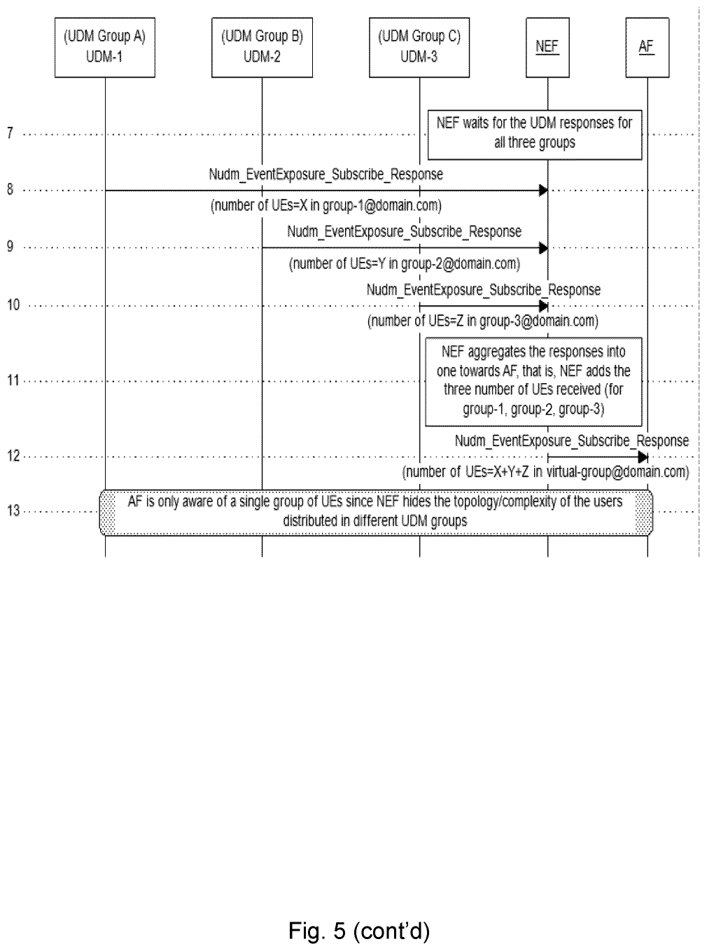

A second particular embodiment for handling groups of UEs 85 in a core network based on at least some of the above disclosed embodiments will now be disclosed in detail with reference to the signalling diagram of FIG. 5. This embodiment represents a scenario where groups of UEs are created by the MNO.
S401: MNO has created three groups of UEs (i.e., three External Group Identifiers), one for each UDM group. Each group contains UE members being served by (or belonging to) each UDM group. Additionally, MNO has configured in NEF that a single virtual External Group Identifier is associated to those three External Group Identifiers.
S402-S406: AF subscribes to an event for the “virtual” group of UEs. Since NEF has been configured to detect and map the “virtual” group of UEs to the three External Group of UEs, NEF initiates the subscription to those three groups of UEs.
S407-S412: NEF waits for the three UDM responses. Since each UDM will return the number of UEs for the External Group Identifier managed, NEF aggregates the total number of UEs and returns it to AF.

This embodiment enables AF to use a single External Group Identifier since NEF hides the complexity of the 5GC network and partitioning of UEs.

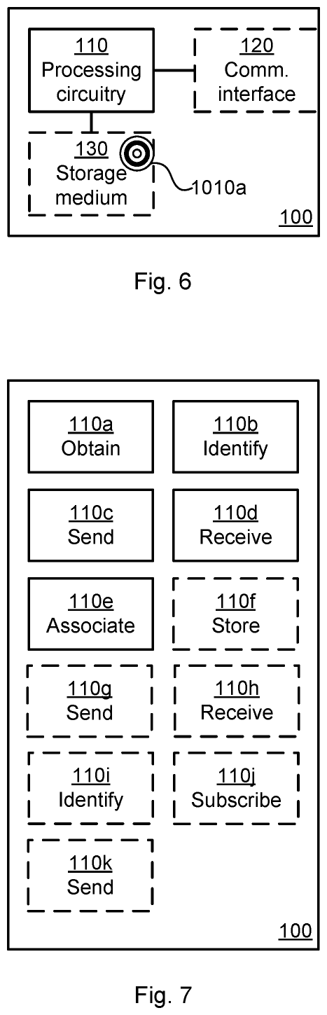

FIG. 6 schematically illustrates, in terms of a number of functional units, the components of an NEF node 100 according to an embodiment. Processing circuitry 110 is provided using any combination of one or more of a suitable central processing unit (CPU), multiprocessor, microcontroller, digital signal processor (DSP), etc., capable of executing software instructions stored in a computer program product 1010a (as in FIG. 10), e.g. in the form of a storage medium 130. The processing circuitry 110 may further be provided as at least one application specific integrated circuit (ASIC), or field programmable gate array (FPGA).

Particularly, the processing circuitry 110 is configured to cause the NEF node 100 to perform a set of operations, or steps, as disclosed above. For example, the storage medium 130 may store the set of operations, and the processing circuitry 110 may be configured to retrieve the set of operations from the storage medium 130 to cause the NEF node 100 to perform the set of operations. The set of operations may be provided as a set of executable instructions. Thus the processing circuitry 110 is thereby arranged to execute methods as herein disclosed.

The storage medium 130 may also comprise persistent storage, which, for example, can be any single one or combination of magnetic memory, optical memory, solid state memory or even remotely mounted memory.

The NEF node 100 may further comprise a communications interface 120 for communications with other entities, nodes, functions, and devices, as in the communication network 10. As such the communications interface 120 may comprise one or more transmitters and receivers, comprising analogue and digital components.

The processing circuitry 110 controls the general operation of the NEF node 100 e.g. by sending data and control signals to the communications interface 120 and the storage medium 130, by receiving data and reports from the communications interface 120, and by retrieving data and instructions from the storage medium 130. Other components, as well as the related functionality, of the NEF node 100 are omitted in order not to obscure the concepts presented herein.

FIG. 7 schematically illustrates, in terms of a number of functional modules, the components of an NEF node 100 according to an embodiment. The NEF node 100 of FIG. 7 comprises a number of functional modules; an obtain module 110a configured to perform step S102, an identify module 110b configured to perform step S104, a send module 110c configured to perform step S106, a receive module 110d configured to perform step S108, and an associate module 110e configured to perform step S110. The NEF node 100 of FIG. 7 may further comprise a number of optional functional modules, such as any of a store module 110f configured to perform step S112, a send module 110g configured to perform step S114, a receive module 110h configured to perform step S116, an identify module 110i configured to perform step S118, a subscribe module 110j configured to perform step S120, and a send module 110k configured to perform step S122.

In general terms, each functional module 110a: 110k may be implemented in hardware or in software. Preferably, one or more or all functional modules 110a: 110k may be implemented by the processing circuitry 110, possibly in cooperation with the communications interface 120 and/or the storage medium 130. The processing circuitry 110 may thus be arranged to from the storage medium 130 fetch instructions as provided by a functional module 110a: 110k and to execute these instructions, thereby performing any steps of the NEF node 100 as disclosed herein.

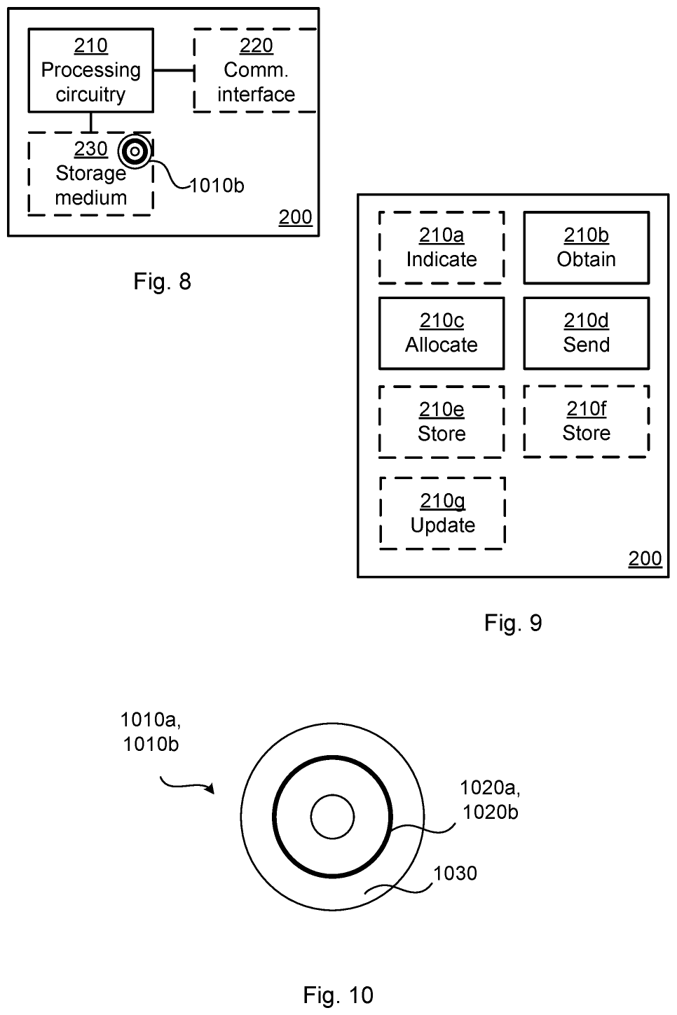

FIG. 8 schematically illustrates, in terms of a number of functional units, the components of a UDM node 200 according to an embodiment. Processing circuitry 210 is provided using any combination of one or more of a suitable central processing unit (CPU), multiprocessor, microcontroller, digital signal processor (DSP), etc., capable of executing software instructions stored in a computer program product 1010b (as in FIG. 10), e.g. in the form of a storage medium 230. The processing circuitry 210 may further be provided as at least one application specific integrated circuit (ASIC), or field programmable gate array (FPGA).

Particularly, the processing circuitry 210 is configured to cause the UDM node 200 to perform a set of operations, or steps, as disclosed above. For example, the storage medium 230 may store the set of operations, and the processing circuitry 210 may be configured to retrieve the set of operations from the storage medium 230 to cause the UDM node 200 to perform the set of operations. The set of operations may be provided as a set of executable instructions. Thus the processing circuitry 210 is thereby arranged to execute methods as herein disclosed.

The storage medium 230 may also comprise persistent storage, which, for example, can be any single one or combination of magnetic memory, optical memory, solid state memory or even remotely mounted memory.

The UDM node 200 may further comprise a communications interface 220 for communications with other entities, nodes, functions, and devices, as in the communication network 10. As such the communications interface 220 may comprise one or more transmitters and receivers, comprising analogue and digital components.

The processing circuitry 210 controls the general operation of the UDM node 200 e.g. by sending data and control signals to the communications interface 220 and the storage medium 230, by receiving data and reports from the communications interface 220, and by retrieving data and instructions from the storage medium 230. Other components, as well as the related functionality, of the UDM node 200 are omitted in order not to obscure the concepts presented herein.

FIG. 9 schematically illustrates, in terms of a number of functional modules, the components of a UDM node 200 according to an embodiment. The UDM node 200 of FIG. 9 comprises a number of functional modules; an obtain module 210b configured to perform step S204, an allocate module 210c configured to perform step S206, and a send module 210d configured to perform step S208. The UDM node 200 of FIG. 9 may further comprise a number of optional functional modules, such as any of an indicate module 210a configured to perform step S202, a store module 210e configured to perform step S210, a store module 210f configured to perform step S212, and an update module 210g configured to perform step S214.

In general terms, each functional module 210a: 210g may be implemented in hardware or in software. Preferably, one or more or all functional modules 210a: 210g may be implemented by the processing circuitry 210, possibly in cooperation with the communications interface 220 and/or the storage medium 230. The processing circuitry 210 may thus be arranged to from the storage medium 230 fetch instructions as provided by a functional module 210a: 210g and to execute these instructions, thereby performing any steps of the UDM node 200 as disclosed herein.

Any of the NEF node 100 and the UDM node 200 may be provided as a standalone device or as a part of at least one further device. For example, the NEF node 100 and the UDM node 200 may be provided in one or more nodes of the core network. Alternatively, functionality of the NEF node 100 and the UDM node 200 may be distributed between at least two devices, or nodes. A first portion of the instructions performed by the NEF node 100 and the UDM node 200 may be executed in a respective first device, and a second portion of the instructions performed by the NEF node 100 and the UDM node 200 may be executed in a respective second device; the herein disclosed embodiments are not limited to any particular number of devices on which the instructions performed by the NEF node 100 and the UDM node 200 may be executed. Hence, the methods according to the herein disclosed embodiments are suitable to be performed by an NEF node 100 and the UDM node 200 residing in a cloud computational environment. Therefore, although a single processing circuitry 110, 210 is illustrated in FIGS. 6 and 8 the processing circuitry 110, 210 may be distributed among a plurality of devices, or nodes. The same applies to the functional modules 110a: 110k, 210a: 210g of FIGS. 7 and 9 and the computer programs 1020a, 1020b of FIG. 10.

FIG. 10 shows one example of a computer program product 1010a, 1010b comprising computer readable means 1030. On this computer readable means 1030, a computer program 1020a can be stored, which computer program 1020a can cause the processing circuitry 110 and thereto operatively coupled entities and devices, such as the communications interface 120 and the storage medium 130, to execute methods according to embodiments described herein. The computer program 1020a and/or computer program product 1010a may thus provide means for performing any steps of the NEF node 100 as herein disclosed. On this computer readable means 1030, a computer program 1020b can be stored, which computer program 1020b can cause the processing circuitry 210 and thereto operatively coupled entities and devices, such as the communications interface 220 and the storage medium 230, to execute methods according to embodiments described herein. The computer program 1020b and/or computer program product 1010b may thus provide means for performing any steps of the UDM node 200 as herein disclosed.

In the example of FIG. 10, the computer program product 1010a, 1010b is illustrated as an optical disc, such as a CD (compact disc) or a DVD (digital versatile disc) or a Blu-Ray disc. The computer program product 1010a, 1010b could also be embodied as a memory, such as a random access memory (RAM), a read-only memory (ROM), an erasable programmable read-only memory (EPROM), or an electrically erasable programmable read-only memory (EEPROM) and more particularly as a non-volatile storage medium of a device in an external memory such as a USB (Universal Serial Bus) memory or a Flash memory, such as a compact Flash memory. Thus, while the computer program 1020a, 1020b is here schematically shown as a track on the depicted optical disk, the computer program 1020a, 1020b can be stored in any way which is suitable for the computer program product 1010a, 1010b.

The inventive concept has mainly been described above with reference to a few embodiments. However, as is readily appreciated by a person skilled in the art, other embodiments than the ones disclosed above are equally possible within the scope of the inventive concept, as defined by the appended patent claims.

1. A method for handling groups of User Equipment, UE, in a core network, the method being performed by Network Exposure Function, NEF, node in the core network, the method comprising:
obtaining an indication that a group of UEs is formed, wherein the group of UEs is associated with a single virtual External Group Identifier;
identifying to which Unified Data Management, UDM, group each of the UEs belongs, wherein each UDM group comprise at least one UDM node;
sending a request to each identified UDM group for the UEs to be added to the group of UEs, and for each identified UDM group to, for the group of UEs, allocate a respective External Group Identifier which will serve the group of UEs;
receiving, from each identified UDM group, a respective External Group Identifier for the group of UEs; and
associating all the received External Group Identifiers with the single virtual External Group Identifier.

2. The method according to claim 1, wherein the indication that the group of UEs is formed is obtained either from an Application Function, AF, node or from a Mobile Network Operator, MNO, node.

3. The method according to claim 1, wherein identifying to which UDM group each of the UEs belongs involves performing a discovery procedure with a Network Repository Function, NRF, node.

4. The method according to claim 1, wherein the method further comprises:
storing an association between the received External Group Identifiers and the single virtual External Group Identifier.

5. The method according to claim 1, wherein the method further comprises:
sending a response to an Application Function, AF, node upon having received the External Group Identifiers from the identified UDM groups.

6. The method according to claim 1, wherein the method further comprises:
receiving, from an Application Function, AF, node, a request for exposure related to the group of UEs as identified by the single virtual External Group Identifier;
identifying, based on the single virtual External Group Identifier, that the group of UEs is associated with different External Group Identifiers;
subscribing to events for the group of UEs by sending a request to each UDM group associated with the External Group Identifiers; and
sending a single event subscription response to the AF node as an aggregate of information of responses received from said each UDM group.

7. The method according to claim 1, wherein the core network is a fifth generation, 5G, core network.

8. A method for handling groups of User Equipment, UE, in a core network, the method being performed by a Unified Data Management, UDM, node in the core network, the method comprising:
obtaining a request from a Network Exposure Function, NEF, node, for at least one UE to be added to a group of UEs and to, for the group of UEs, allocate an External Group Identifier which will serve the group of UEs;
allocating the External Group Identifier to the group of UEs; and
sending the External Group Identifier for the group of UEs to the NEF node.

9. The method according to claim 8, wherein the request comprises a single virtual External Group Identifier for the group of UEs, and wherein the single virtual External Group Identifier is common for all groups of UDMs serving the group of UEs.

10. The method according to claim 9, wherein the method further comprises:
storing an association between the External Group Identifier and the single virtual External Group Identifier.

11. The method according to claim 9, wherein the method further comprises:
storing group data of the group of UEs, wherein the single virtual External Group Identifier is stored as part of the group data.

12. The method according to claim 9, wherein the UDM node has a Network Function, NF, profile, and wherein the method further comprises:
updating the NF profile to indicate that UEs of the External Group Identifier and the single virtual External Group Identifier are served by the UDM node.

13. The method according to claim 8, wherein the UDM node is part of a UDM group, and wherein the method further comprises:
indicating to a Network Repository Function, NRF, node that partial notifications of Network Function, NF, profiles for the UDM group are to be sent to the UDM node only when there is a change in External Group Identifiers support in the UDM group.

14. (canceled)

15. A Network Exposure Function, NEF, node for handling groups of User Equipment, UE, in a core network, the NEF node comprising processing circuitry, the processing circuitry being configured to cause the NEF node to:
obtain an indication that a group of UEs is formed, wherein the group of UEs is associated with a single virtual External Group Identifier;
identify to which Unified Data Management, UDM, group each of the UEs belongs, wherein each UDM group comprise at least one UDM node;
send a request to each identified UDM group for the UEs to be added to the group of UEs, and for each identified UDM group to, for the group of UEs, allocate a respective External Group Identifier which will serve the group of UEs;
receive, from each identified UDM group, a respective External Group Identifier for the group of UEs; and
associate all the received External Group Identifiers with the single virtual External Group Identifier.

16. (canceled)

17. (canceled)

18. A Unified Data Management, UDM, node for handling groups of User Equipment, UE, in a core network, the UDM node comprising processing circuitry, the processing circuitry being configured to cause the UDM node to:
obtain a request from a Network Exposure Function, NEF, node, for at least one UE to be added to a group of UEs and to, for the group of UEs, allocate an External Group Identifier which will serve the group of UEs;
allocate the External Group Identifier to the group of UEs; and
send the External Group Identifier for the group of UEs to the NEF node.

19-23. (canceled)
